(19) United States
(12) Patent Application Publication
(10) Pub. No.: US 2026/0264704 A1
(43) Pub. Date: Sep. 10, 2026

(54) SYSTEM AND METHOD FOR SENSOR CALIBRATION

(71) Applicant: Torc Robotics, Inc., Blacksburg, VA (US)

(72) Inventors: Chandramouli Gnanasambandham, Stuttgart (DE); Biswanath Behera, Stuttgart (DE); Andre Scholich, Leipzig (DE); Jonas Torzewski, Stuttgart (DE)

(21) Appl. No.: 19/072,369

(22) Filed: Mar. 6, 2025

(51) Int. Cl. B60W 50/02; G01M 17/007

(52) U.S. Cl. CPC B60W 50/0205; G01M 17/007; B60W 2050/0215; B60W 2552/53

(57) ABSTRACT

A system for sensor calibration is provided. The system includes a calibration course including a pathway with sections disposed adjacent to each other and extending along the pathway. The sections have different characteristics relative to each other. The system includes at least one sensor configured to be located on a vehicle, and a processing device in communication with the at least one sensor. The processing device is configured to execute instructions stored in a memory to perform operations that include detecting with the at least one sensor the sections having the different characteristics as the vehicle travels along the pathway of the calibration course. The operations include detecting with the at least one sensor a position of the vehicle relative to the sections of the pathway as the vehicle travels along the pathway of the calibration course.

### TECHNICAL FIELD

The field of the disclosure relates to sensor calibration and, in particular, to a system including a calibration course with features and sensors configured to operate in combination with vehicle sensors to optimize the accuracy of the vehicle sensor calibration process.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. These actions undertaken by the vehicle include steering, braking and acceleration.

The perception technologies of the vehicle include a variety of sensors, each of which must be calibrated appropriately to ensure that the vehicle accurately perceives the environment it is traveling through. Calibration of different sensor types performed using different procedures, and calibration under different operating conditions would be preferred to increase the accuracy of calibration and future sensor operation. However, vehicle sensor calibration is typically performed in the factory prior to launching the vehicle for on-road operation based on manufacturer specifications. As a result, sensors may inadequately or improperly detect objects in an environment as the vehicle travels through the environment after launch.

Accordingly, there exists a need for a system and a method of sensor calibration that provide an on-road verification and calibration of sensor operation prior to launch of the vehicle. These and other needs are met by the exemplary system for sensor calibration discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for sensor calibration is provided. The system includes a calibration course including a pathway with sections (e.g., lines, curves, or the like) disposed adjacent to each other and extending along the pathway. As discussed herein, the term “adjacent” refers to sections immediately adjacent to each other or sections laterally offset relative to each other and disposed near each other laterally. The sections of the calibration course have different characteristics relative to each other. The system includes at least one sensor configured to be located on a vehicle. The system includes a processing device in communication with the at least one sensor. The processing device is configured to execute instructions stored in a memory to perform operations that include detecting with the at least one sensor the sections having the different characteristics as the vehicle travels along the pathway of the calibration course. The operations include detecting with the at least one sensor a position of the vehicle relative to the sections of the pathway as the vehicle travels along the pathway of the calibration course.

In some embodiments, the sections can be lines, and the different characteristics of the lines can include different colors. In some embodiments, the sections with different characteristics can include a central white line, a green line laterally offset from the central white line, a yellow line laterally offset from the green line, and a red line laterally offset from the yellow line. In some embodiments, the sections with different characteristics can include a central white line, first and second green lines laterally offset on opposing sides of the central white line, first and second yellow lines laterally offset on opposing sides of the respective first and second green lines, and first and second red lines laterally offset on opposing sides of the respective first and second yellow lines. The colors of the sections can provide a visual indicator of whether the vehicle is operating under optimal standards (e.g., wheels traveling along green line) or if a misalignment is occurring (e.g., one or more wheels traveling along yellow or red line).

The system can include a database electronically storing a calibration course map including the pathway with the sections having the different characteristics. The operations can include comparing data from the at least one sensor representative of the detected sections having the different characteristics to the calibration course map for accuracy. If an accuracy value is determined to be below a predetermined accuracy threshold, the operations can include calibrating the at least one sensor of the vehicle based on the calibration course map to increase the accuracy value to the predetermined accuracy threshold or higher. In some embodiments, the accuracy threshold for a lateral position can be about, e.g., ±10 cm, or the like, and for a longitudinal position can be about, e.g., ±30 cm, or the like. A higher lateral accuracy can be more critical than a longitudinal accuracy in various scenarios, such as lane-keeping, collision avoidance, or the like, when navigating tight spaces.

In some embodiments, the accuracy threshold can be a ±1 m lateral shift to the right or left of the central axis of the vehicle (or from a particular component of the vehicle from which the lateral distance is measured). In some embodiments, the accuracy threshold can be a 1 m lateral shift over a distance of about 50 meters of travel for the vehicle. The accuracy threshold can be indicative of a vehicle traveling into an adjacent lane. In some embodiments, the accuracy threshold can be different for different types of components of the vehicle. For example, for localization systems (e.g., GNSS, IMU, wheel speed sensors, or the like), the lateral position accuracy can be about, e.g., ±10 cm, or the like, to ensure false detection of lane departure. In some embodiments, the longitudinal position accuracy can be about, e.g., ±30 cm, or the like, to ensure safe stopping at intersections and safe distance keeping.

In some embodiments, the system can include an overview or monitoring unit of the calibration process. In some embodiments, the monitoring unit can be in the form of mission control (or another remote location) which receives data from the system and intervenes if anomalies in the calibration process are detected, e.g., the accuracy value is below the predetermined accuracy threshold. In some embodiments, mission control can include one or more humans reviewing and analyzing the captured data from the calibration course to ensure safe calibration is performed. In some embodiments, the comparison of data discussed herein can be performed automatically and/or semi-automatically and, in some embodiments, can include human oversight.

In some embodiments, detecting the position of the vehicle relative to the sections can include detecting a wheel position relative to the sections of the pathway. In some embodiments, the wheel position can be a trailer wheel position for a trailer coupled to the vehicle. By detecting the wheel position of the trailer, the system allows for early detection of a “dog-legged” trailer due to misalignment of the trailer axle. The operations can include comparing the detected trailer wheel position to an expected trailer wheel position relative to the sections of the pathway based on a speed and trajectory of the vehicle. If the detected trailer wheel position is offset relative to the expected trailer wheel position by greater than a predetermined trailer wheel position threshold, the operations can include identifying a trailer wheel or axle misalignment of the trailer.

In some embodiments, the system can include at least one course sensor disposed at or near the calibration course. In some embodiments, the at least one course sensor can be different from the at least one sensor of the vehicle. The operations can include detecting with the at least one course sensor the sections having the different characteristics as the vehicle travels along the pathway of the calibration course, and comparing course sensor data with data from the at least one sensor of the vehicle for accuracy. If an accuracy value is below a predetermined accuracy threshold, the operations can include calibrating the at least one sensor of the vehicle based on the course sensor data to increase the accuracy value to the predetermined accuracy threshold or higher.

In some embodiments, the operations can include detecting with the at least one course sensor the position of the vehicle relative to the sections of the pathway as the vehicle travels along the pathway of the calibration course, and comparing course sensor data with data from the at least one sensor of the vehicle for accuracy. If an accuracy value is below a predetermined accuracy threshold, the operations can include calibrating the at least one sensor of the vehicle based on the course sensor data to increase the accuracy value to the predetermined accuracy threshold or higher.

In some embodiments, the vehicle can be, e.g., an autonomous vehicle, a semi-autonomous vehicle, a non-autonomous vehicle, or the like. In some embodiments, the at least one sensor can be, e.g., a camera, radar, LiDAR, combinations thereof, or the like.

In another aspect, an exemplary computer-implemented method for sensor calibration is provided. The method includes operating a vehicle along a pathway of a calibration course. The pathway of the calibration course includes sections disposed adjacent to each other and extending along the pathway. The sections have different characteristics relative to each other. The method includes executing instructions stored in a memory with a processing device in communication with at least one sensor configured to be located on the vehicle to perform operations that include detecting with the at least one sensor the sections having the different characteristics as the vehicle travels along the pathway of the calibration course. The operations include detecting with the at least one sensor a position of the vehicle relative to the sections of the pathway as the vehicle travels along the pathway of the calibration course.

In some embodiments, the operations can include comparing data from the at least one sensor representative of the detected sections having the different characteristics to a calibration course map for accuracy. If an accuracy value is below a predetermined accuracy threshold, the operations include calibrating the at least one sensor of the vehicle based on the calibration course map to increase the accuracy value to the predetermined accuracy threshold or higher.

In some embodiments, the operations can include detecting the position of the vehicle relative to the sections by detecting a wheel position relative to the sections of the pathway. The operations can include comparing the detected wheel position to an expected wheel position relative to the sections of the pathway. If the detected wheel position is offset relative to the expected wheel position by greater than a predetermined wheel position threshold, the operations can include identifying a wheel or axle misalignment of the vehicle.

In another aspect, an exemplary system for sensor calibration is provided. The system includes a calibration course including a pathway extending in a figure eight (8) configuration such that the pathway forms a first loop and a second loop connected at an intersection. The system includes at least one course sensor and a processing device in communication with the at least one sensor. The processing device is configured to execute instructions stored in a memory to perform operations that include detecting with the at least one course sensor a position of the vehicle as the vehicle travels along the pathway of the calibration course.

In some embodiments, the first loop and the second loop can be substantially equal in length, size and configuration. In some embodiments, the figure eight (8) configuration can be an offset figure eight (8) configuration such that the first loop is smaller than the second loop. In such embodiments, the intersection can be offset from a center of the calibration course.

In some embodiments, the system can include a traffic light disposed at the intersection. In some embodiments, the pathway can include sections with different surfaces for testing operation of the vehicle. In some embodiments, the sections can include a first section with asphalt, and a second section offset from the first section and including gravel. In some embodiments, the sections can include, e.g., concrete, dirt, compressed ground, asphalt, gravel, moisture/water, combinations thereof, or the like. In some embodiments, the pathway can include at least one section with a non-inclined or flat roadway and at least one section with an inclined roadway. In some embodiments, the pathway can include at least one tunnel.

The vehicle can include at least one vehicle sensor configured to detect characteristics of the pathway as the vehicle travels along the pathway of the calibration course. The at least one course sensor can be configured to detect the characteristics of the pathway as the vehicle travels along the pathway. The characteristics of the pathway can include at least one of lane markings, traffic signs, traffic signals, other vehicles, non-vehicle roadway participants, or objects at or near the pathway. The operations can include comparing data from the at least one course sensor to data from the at least one vehicle sensor. If an accuracy value is below a predetermined accuracy threshold, the operations can include calibrating the at least one vehicle sensor based on data from the at least one course sensor.

The vehicle can include at least one vehicle sensor configured to detect vehicle characteristics as the vehicle travels along the pathway. The at least one course sensor can be configured to detect the vehicle characteristics as the vehicle travels along the pathway. The vehicle characteristics can include at least one of a wheel position, an axle position, a lane position, a velocity, an acceleration, or a trajectory. The operations can include comparing data from the at least one course sensor to data from the at least one vehicle sensor. If an accuracy value is below a predetermined accuracy threshold, the operations can include calibrating the at least one vehicle sensor based on data from the at least one course sensor.

In some embodiments, the vehicle can be, e.g., an autonomous vehicle, a semi-autonomous vehicle, a non-autonomous vehicle, or the like. In some embodiments, the at least one sensor can be, e.g., a camera, radar, LiDAR, combinations thereof, or the like.

In another aspect, an exemplary computer-implemented method for sensor calibration is provided. The method includes operating a vehicle along a pathway of a calibration course. The pathway extends in a figure eight (8) configuration such that the pathway forms a first loop and a second loop connected at an intersection. The method includes executing instructions stored in a memory with a processing device in communication with at least one course sensor to perform operations that include detecting with the at least one course sensor a position of the vehicle as the vehicle travels along the pathway of the calibration course.

In some embodiments, the vehicle can include at least one vehicle sensor configured to detect characteristics of the pathway as the vehicle travels along the pathway of the calibration course. The at least one course sensor can be configured to detect the characteristics of the pathway as the vehicle travels along the pathway. The operations can include comparing data from the at least one course sensor to data from the at least one vehicle sensor. If an accuracy value is below a predetermined accuracy threshold, the operations can include calibrating the at least one vehicle sensor based on data from the at least one course sensor.

In some embodiments, the vehicle includes at least one vehicle sensor configured to detect vehicle characteristics as the vehicle travels along the pathway. The at least one course sensor can be configured to detect the vehicle characteristics as the vehicle travels along the pathway. The operations can include comparing data from the at least one course sensor to data from the at least one vehicle sensor. If an accuracy value is below a predetermined accuracy threshold, the operations can include calibrating the at least one vehicle sensor based on data from the at least one course sensor.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for sensor calibration.

FIG. 7 is a flowchart of a method for sensor calibration based on detection of different characteristics of pathway sections of a calibration course.

FIG. 8 is a diagrammatic top view of a calibration course of an exemplary system for sensor calibration, including a single course sensor and pathway sections with different characteristics.

FIG. 9 is a diagrammatic top view of a calibration course of an exemplary system for sensor calibration, including multiple course sensors and pathway sections with different characteristics.

FIG. 10 is a diagrammatic top view of a calibration course of an exemplary system for sensor calibration, including a single course sensor and pathway sections with different characteristics configured in a mirror image from a central line.

FIG. 11 is a diagrammatic front view of a calibration course of an exemplary system for sensor calibration, including a vehicle positioned on the pathway sections.

FIG. 12 is a diagrammatic top view of a figure 8 calibration course of an exemplary system for sensor calibration, including first and second loops of substantially equal configurations and dimensions.

FIG. 13 is a diagrammatic top view of a figure 8 calibration course of an exemplary system for sensor calibration, including first and second loops of an offset configuration and dimension.

FIG. 14 is a flowchart of a method for sensor calibration on a calibration course having a substantially figure 8 configuration.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

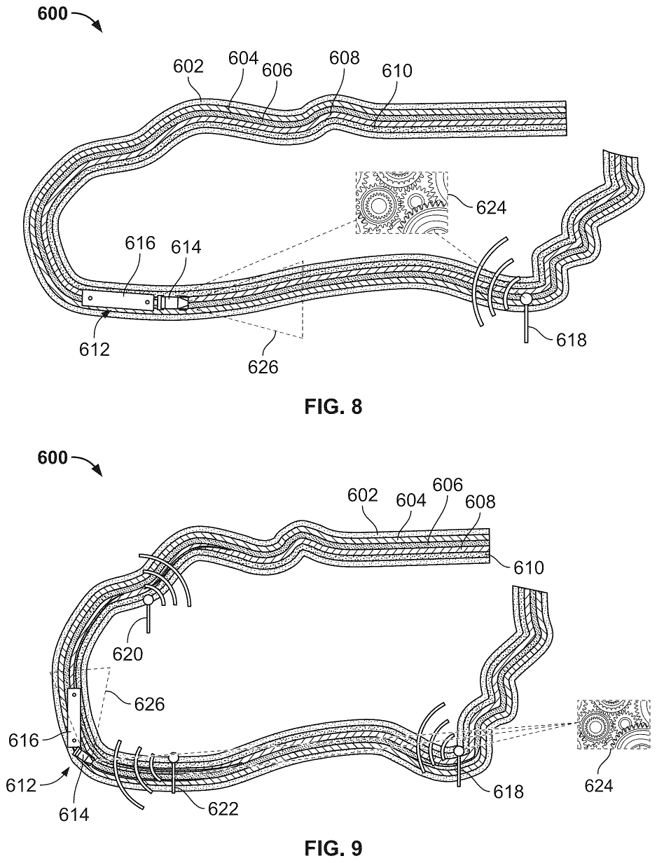

The exemplary system for sensor calibration includes a calibration course with features that provides an environment in which vehicle sensors can be accurately calibrated in an environment that mimics on-road conditions. The calibration course can include a pathway with lines having different characteristics, and a combination of vehicle sensor and course sensor data can be used to determine if the vehicle sensors are accurately detecting features associated with the pathway, the environment and/or the vehicle. The calibration course can include a substantially figure 8 configuration that provides for efficient testing conditions with potentially non-stop travel of the vehicle. The calibration course can include various features that mimic different driving conditions to test the vehicle sensors in different operating scenarios.

The exemplary system provides for calibration and anomaly detection prior to departure or launch of the vehicle on a mission. The system is scalable and cost-efficient by using a closed-course calibration course. The system can be automated to decrease errors typically encountered due to human intervention, thereby improving sensor calibration accuracy. The system can implement different sensor modalities and static beacons/sensors to update sensor calibration parameters in real-time (or substantially real-time). The course sensors can be the same or different from the vehicle sensors to calibrate the vehicle sensors with different types of data input to the system. A central processing unit (e.g., at mission control, or the like) can be used to process the data received from the sensors associated with the system.

In some embodiments, the vehicle sensor data can be compared to known calibration course data programmed into the system based on the configuration and features of the calibration course. In some embodiments, the vehicle sensor data can be compared to data captured by the course sensors, which can in turn provide a more accurate and higher precision data quality as compared to the vehicle sensors. The vehicle sensors can therefore be calibrated during dynamic maneuvers along the calibration course based on substantially real-time anomaly detection, ensuring that adjustments to the vehicle sensor calibration are performed to improve overall vehicle operation.

The vehicle sensor calibration can be performed to improve the perception by the sensors of the environment and/or objects around the vehicle. The vehicle sensor calibration can also be performed to improve the perception of vehicle characteristics. In some embodiments, the course and vehicle sensors can be used to detect operational anomalies associated with the vehicle. For example, the operational anomaly can involve the alignment of wheels and/or axles of the trailer coupled to the vehicle. The sensor data can be used to determine if trailer misalignment is occurring, which is referred to in the industry as a “dog-legged” trailer. Such trailer misalignment can lead to excess fuel consumption and, in a worst-case scenario, to jackknifing, i.e., a vehicle accident. The system can be used to detect the trailer axle misalignment, which can be reported via an alert to, e.g., mission control, or the like, to perform maintenance for corrective action. The system can therefore be used to ensure adequate calibration of onboard sensors in a controlled, closed-loop calibration course, and to detect anomalies with the vehicle.

In some embodiments, the pathway of the calibration course can include lines with different characteristics to detect if the vehicle is driving correctly and accurately within the lines, e.g., determining if the vehicle is capable of maintaining its position within lanes on a roadway. In some embodiments, the different characteristics can be different colors. For example, a central white line can be used with green, yellow and red lines on both sides of the white line. The characteristics of the course, including the position of the lines along the entire course, can be programmed into the system. As the vehicle travels along the pathway, the vehicle sensors can detect the position of the vehicle relative to the differently colored lines, as well as the lines themselves and any other characteristics associated with the pathway.

Simultaneously, strategically positioned course sensors (e.g., static sensors along the course) can be used to detect the position of the vehicle relative to the differently colored lines, as well as any other characteristics associated with the pathway. In some embodiments, the course sensors can use a different sensing modality with a higher precision that the vehicle sensors to provide higher precision data for calibration of the vehicle sensors. The vehicle and course sensors can include, e.g., cameras, microphones, radar, LiDAR, combinations thereof, or the like. The data from the vehicle sensors and the course sensors (as well as the known course map features) can be compared and, if anomalies exists in the data, the vehicle sensors can be calibrated based on the course sensor data. Data from the course sensors can capture features associated with axles of the vehicle and/or the trailer coupled to the vehicle, allowing for a determination whether trailer misalignment is occurring.

In some embodiments, the calibration course can be in a figure 8 or an offset figure 8 configuration. This configuration allows for a substantially continuous operation of the vehicle along the calibration course if extended testing and calibration is needed. The configuration allows for the optimal use of an environment space for testing and calibration of the vehicle. The figure 8 configuration allows for left and right agnostic or symmetric calibration of sensors. In some embodiments, the calibration course can include various features to test the vehicle operation (and sensor operation) in different scenarios. In some embodiments, the various features can include, e.g., banked roads, bumpy roads, uneven roads, sloping roads, gravel roads, wet roads, road signs, traffic lights, combinations thereof, or the like, to better represent a real-world environment. The course sensors can be used to monitor operation of the vehicle along the calibration course, and the vehicle sensor data can be compared to the course sensor data to determine if calibration of the vehicle sensors is needed based on detected anomalies in the capture data.

The exemplary system therefore provides for optimized sensor calibration in a substantially real-world environment to improve overall perception operation of the vehicle. The system can provide end-to-end calibration based on feedback similar to the application/target environment in which the vehicle will operate. The system allows for calibration routines based on dynamic driving maneuvers (rather than static factory calibration), and the dynamic calibration yields increased calibration quality of the sensors. The notion of time between various sensors (e.g., time alignment) can be performed in the controlled environment. Calibration is performed within a closed-course, drastically minimizing any potential safety risks typically encountered during dynamic sensor calibration. Different sensor modalities of the course sensors provides for increased variety of data against which the vehicle sensors are calibrated. The system can operate in a fully automated manner without human intervention based on the communication and comparison of data between the vehicle sensors and course sensors, reducing potential errors encountered during human-performed sensor calibration.

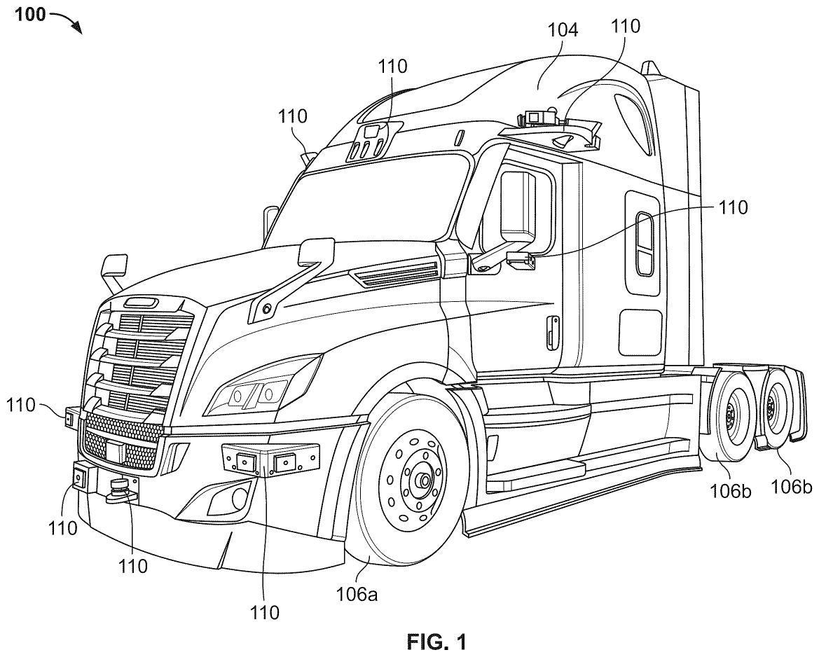

Various embodiments in the present disclosure are described with reference to FIGS. 1-14 below.

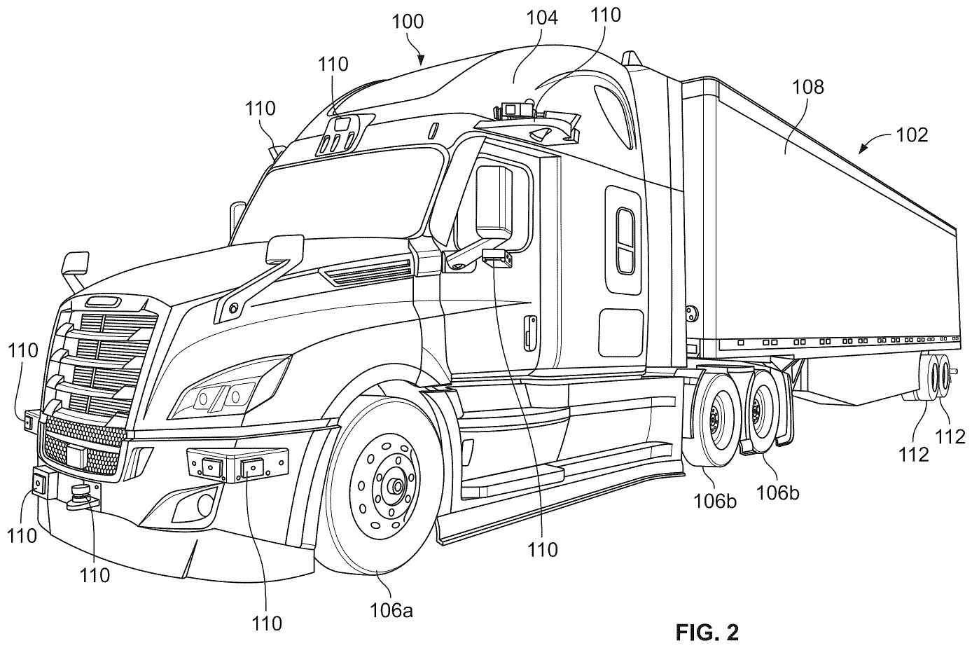

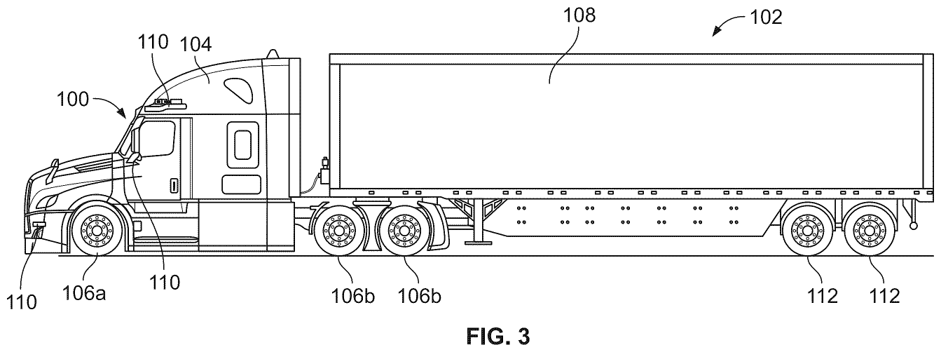

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

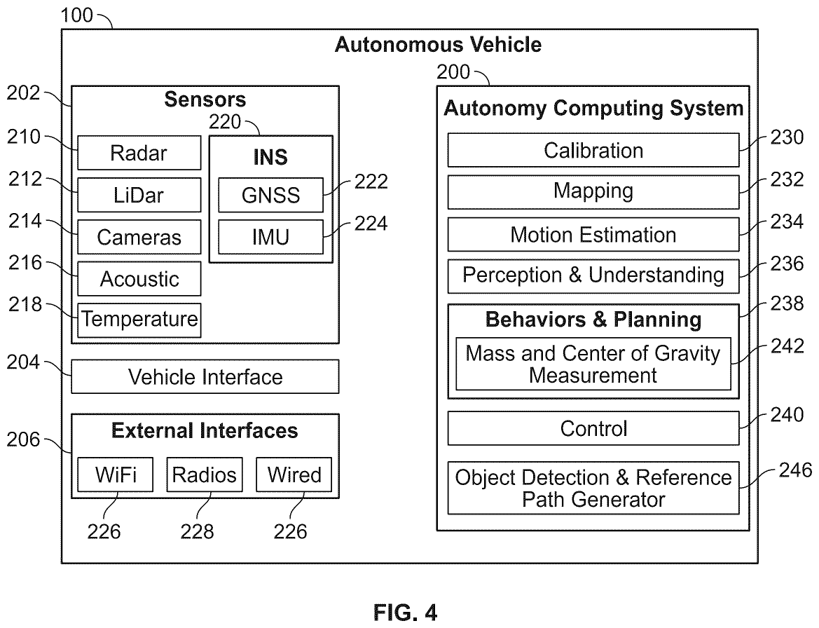

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

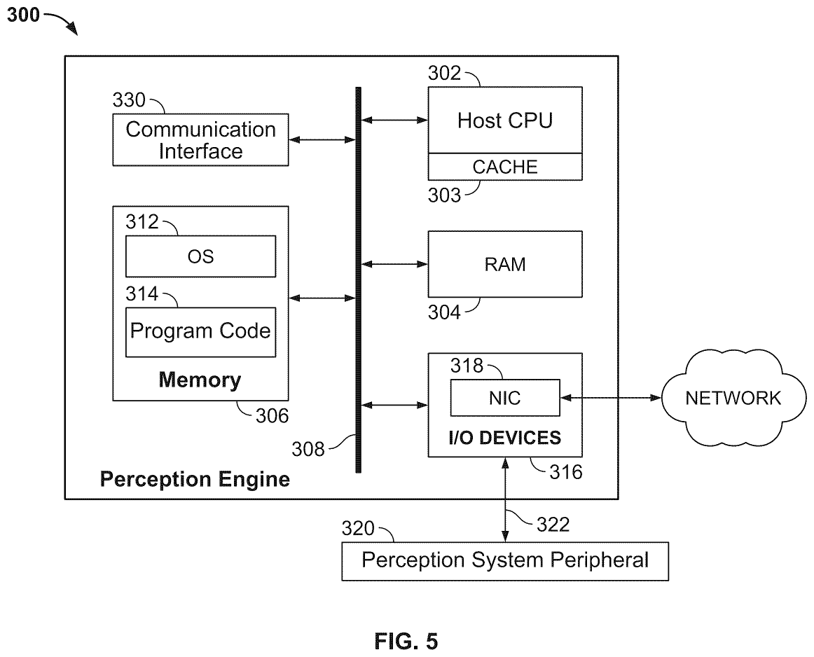

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

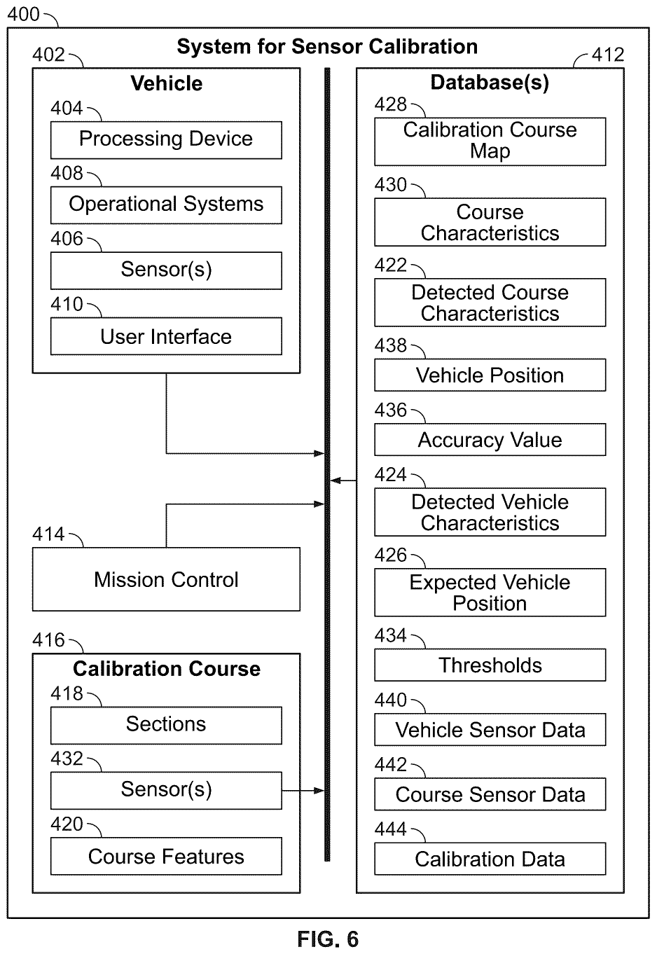

FIG. 6 is a block diagram of an exemplary system 400 for sensor calibration for a vehicle. The system 400 generally includes one or more vehicles 402 (e.g., autonomous vehicle 100, semi-autonomous vehicle, and/or non-autonomous vehicle). The vehicle 402 includes a processing device 404 (e.g., computing system 200, computing system 300, or the like) configured to receive and process data for calibration of sensors 406 of the vehicle 402, and/or for determining if components of the vehicle 402 should be corrected for proper operation of the vehicle 402 (e.g., correction of axle misalignment, or the like). The vehicle 402 can include one or more operational systems 408 (e.g., mapping 232, motion estimation 234, perception and understanding 236, behaviors and planning 242, control 240, object detection and reference path generator 246, combinations thereof, or the like) for operating the vehicle 402 within an environment.

The vehicle 402 can include one or more sensors 406 (e.g., sensors 202) for detecting the environment and objects within the environment around the vehicle 402. The sensors 406 are usable as part of the calibration process to be performed by the system 400. The vehicle 402 includes a user interface 410 (e.g., vehicle interface 204) configured to receive/transmit and display data for operation of the system 400, as well as the vehicle 402 itself. The vehicle 402 can include one or more databases 412 (e.g., memory 306) configured to receive and electronically store data. In some embodiments, the database 412 can be stored externally from the vehicle 402 and the vehicle 402 can be in communication with the external database 412 for receiving and/or transmitting data associated with the system 400. In some embodiments, the database 412 can be located at mission control 414 (or at any other external location proximate a control unit) external to the vehicle 402 and in communication with the vehicle 402. In some embodiments, the database 412 can be located on the vehicle 402 itself. In some embodiments, one or more portions of the database 412 can be distributed across components of the system 400. The database 412 can store information relating to calibration of sensors 406 of the vehicle 402.

Rather than (or in addition to) calibrating the sensors 406 of the vehicle 402 in the factory prior to launch, the sensors 406 can be calibrated on a calibration course 416 of the system 400. The calibration course 416 is a physical roadway with components configured to allow for precise calibration of the sensors 406 during dynamic maneuvering of the vehicle 402 along the calibration course 416. The calibration course 416 can include a roadway or pathway with lines sections 418 (e.g., lines, curves, or the like) on the pathway. The sections 418 can be painted or otherwise coupled to the surface of the pathway. The sections 418 have different characteristics that assist with calibration of the sensors 406. In some embodiments, the sections 418 can be of different, e.g., colors, textures, or the like.

In some embodiments, pressure sensitive material or sensors (e.g., sensors 432) can be used in or incorporated into the pathway surface (instead of or in combination with the different colors). The pressure sensitive material can capture and track the pressure applied when the vehicle 402 travels over the surface of the pathway. The material can include or incorporates sensors that transmit data to the processing device 404 (or a processing device associated with mission control) to track in real-time the pressure applied by the vehicle 402 to the pathway. The pressure data can be used to localize the vehicle 402 more precisely (e.g., ±1 cm, or the like) with respect to lane edges and/or the sections 418. The pressure data can be used to more accurately calibrate the sensors 406 of the vehicle 402.

In some embodiments, the sections 418 can include a primary central line (e.g., a white line), secondary lines (e.g., green lines) laterally offset on each side of the central line, tertiary lines (e.g., yellow lines) laterally offset on each side of the secondary lines, and quaternary lines (e.g., red lines) laterally offset on each side of the tertiary lines. Other than the primary central lines, the other lines can be formed in pairs on opposing sides and act as visual and/or textural markers for determining the position of the vehicle 402 (and/or wheels of the vehicle 402) as the vehicle 402 moves along the calibration course 416.

The calibration course 416 can include various turns, slopes, or combinations thereof, to mimic a real-world environment for testing and calibration of the sensors 406. The calibration course 416 can include multiple course features 420 to further mimic different real-world environment scenarios for testing of the vehicle 402 and/or the sensors 406. The features 420 can include, e.g., concrete areas, paved areas, gravel areas, grass areas, loose dirt areas, wet areas, intersections, crosswalks, tunnels, bridges, traffic lights, road signs, other vehicles, combinations thereof, or the like.

As the vehicle 402 travels along the calibration course 416, the sensors 406 detect the sections 418 of the calibration course 416. The data from the vehicle sensors 406 can generally be referred to as vehicle sensor data 440. This data can be stored as detected course characteristics 422. The sensors 406 can be used to detect the position of the vehicle 402 (e.g., wheels of the vehicle 402) relative to the sections 418, and/or the velocity, trajectory and/or acceleration/deceleration of the vehicle 402. This data can be stored as the detected vehicle characteristics 424. The position of the wheels of the vehicle 402 relative to the sections 418 can be indicative of whether the vehicle 402 is traveling appropriately along the course 416.

For example, the desired operation can be with all wheels of the vehicle 402 travelling along the green sections 418 to indicate aligned travel of the vehicle 402 along the sections 418. However, sensors 406 detecting wheels positioned in the yellow or red lines, can be indicative of misalignment of the wheels/axles or improper operation of the vehicle 402. The sensors 406 can detect the wheel position relative to the lines (e.g., sections 418) and data from the sensors 432 of the calibration course 416 can be used to determine the accuracy of the sensors 406 of the vehicle 402. In particular, data from the sensors 406 can be compared to data from the sensors 432 t determine its accuracy. If the accuracy falls below a predetermined threshold, the system 400 can calibrate the sensors 406. As an example, onboard cameras and/or LiDAR mounted near the wheels of the vehicle 402 can be used to detect lane lines and wheel positions. Using machine learning models, the system 400 can determine the distance between the wheel and lane edge, with enhancement of the images/data available based on environment conditions. By placing high-precision GPS reference stations or sensors 432 (e.g., sensors 618, 622 of FIGS. 8 and 9) around the calibration course 416, the position of the vehicle 402 (including the position of each wheel) can be measured with sub-centimeter accuracy. Similarly, the sensors 406 can be used to detect the wheel position of the trailer coupled to the vehicle 402 to determine if the trailer wheels are properly aligned or misaligned (e.g., dog-legged).

In some embodiments, the determination of whether the alignment of the vehicle 402 and/or the trailer is proper can be based on a comparison of the detected vehicle characteristics 424 relative to the expected vehicle position 426. The expected vehicle position 426 can be programmed into the system 400 based on, e.g., the calibration course map 428, known calibration course characteristics 430, combinations thereof, or the like, and based on the vehicle 402 characteristics. For example, the expected vehicle position 426 can be determined based on the size, speed and acceleration of the vehicle 402 as it travels along a curve of the calibration course 416.

In some embodiments, the system 400 can compare the sensor 406 data indicative of the detected course characteristics 422 and the detected vehicle characteristics 424 relative to the expected vehicle position 426, the calibration course map 428, and the course characteristics 430, and (as a result of the comparative data analysis) can determine if the data from the sensors 406 matches the known or expected course 416 or vehicle 402 information. If a match of the data relative to the known information is found, the sensors 406 are appropriately calibrated and no calibration action needs to be taken. In some embodiments, the comparison of the data can be stored as an accuracy value 436 based on the matching percentage of the data.

However, if the data from the sensors 406 does not match within a predetermined threshold 434 value or range, e.g., the accuracy value 436 is outside of the threshold 434 value or range, calibration action of the specific sensors 406 is performed automatically by the system 400. The calibration steps and details can be stored as calibration data 444. The threshold 434 values can be programmed into the system 400 and can be based on, e.g., operating specifications of the respective sensors 406. For example, a lateral position accuracy threshold 434 can be about, e.g., ±10 cm, or the like, to ensure false detection of lane departure, and a longitudinal position accuracy threshold 434 can be about, e.g., ±30 cm, or the like, to ensure safe stopping at intersections and safe distance keeping. However, the thresholds 434 can be adjusted based on the desired calibration parameters and vehicle 402 operating parameters. It should be understood that the calibration process can be performed based on data captured by the sensors 406 associated with the vehicle 402 and/or with the calibration course 416.

In some embodiments, the calibration course 416 can include one or more static sensors 432 disposed adjacent to or on the pathway. The sensors 432 can be the same or different sensor modalities relative to the sensors 406. For example, the sensors 406, 432 can be, e.g., cameras, microphones, radar, LiDAR, or the like. In some embodiments, the sensors 432 can be of higher precision and accuracy relative to the sensors 406 to provide higher precision data for calibration of the sensors 406 of the vehicle 402.

As the vehicle 402 moves along the calibration course 416, the sensors 432 can capture the position of the vehicle 402 (e.g., vehicle position 438), and can further capture detected course characteristics 422. The data from the course sensors 432 can generally be referred to as course sensor data 442. The system 400 can receive as input the data from the vehicle sensors 406 (e.g., vehicle sensor data 440) and the data from the course sensors 432 (e.g., course sensor data 442), and compares the data to determine the matching or accuracy value 436. If the accuracy value 436 is outside of the predetermined threshold 434 for a specific sensor 406 due to anomalies or discrepancies of the sensor 406 data relative to the sensor 432 data, the system 400 can automatically take action to calibrate the sensors 406 to ensure accuracy of perception (e.g., calibration data 444). If the accuracy value 436 is within the threshold 434, no calibration action is taken by the system 400.

As an example, if the vehicle sensors 406 detect the wheels of the vehicle 402 to be along green lines or sections 418 of the calibration course 416, but the course sensors 432 detect that the wheels of the vehicle 402 are on the yellow or red lines or sections 418 of the calibration course 416, an anomaly and lack of matching can be determined. The lack of matching results in an accuracy value 436 outside of the threshold 434, resulting in an automatic calibration action of the sensors 406. The data can be captured again to ensure the updated or calibrated sensors 406 capture data that is within the threshold 434. The calibration process can be repeated until the thresholds 434 are met. If, after several attempts the accuracy value 436 continues to be outside of the thresholds 434, the system 400 can generate an alert to, e.g., mission control 414, requesting manual intervention. It should be understood that the comparison of the vehicle and sensor data 440, 442 can be performed for any detected characteristics or objects associated with the vehicle 402 and/or the calibration course 416, and calibration can be performed for the sensors 406 as needed based on the results of the comparison.

In some embodiments, the calibration course map 428 can be used to calibrate the sensors 406 of the vehicle 402. The map 428 can include a high-fidelity, three-dimensional map of the calibration course 416. The data includes the exact position of the sensors 432, the exact position and configuration of the features 420 (e.g., traffic lights, trees, traffic signs, or the like), and the exact location of the sections 418 along the course 416. The high-fidelity, three-dimensional map of the course 416 is compared to the three-dimensional map or environment perceived by the onboard sensors 406 of the vehicle 402 after traveling (or during travel) along the course 416. The delta or difference between the two maps or data representative of the maps provides an accuracy value 436 to determine if calibration of the sensors 406 is needed. If the calibration quality or accuracy value 436 falls below a predetermined threshold 434, an optimization algorithm can adjust the calibration parameters for each sensor 406 to improve the alignment between the actual data from the map 428 and the perceived three-dimensional map from the sensors 406.

In some embodiments, the vehicle sensors 406 and/or the course sensors 432 can be used to determine if misalignment of one or more wheels of the vehicle 402 and/or the trailer associated with the vehicle 402 is occurring. For example, the vehicle and/or course sensor data 440, 442 can be compared to the expected vehicle position 426 to determine if the wheels are misaligned. If the front trailer wheels are traveling along the green lines or sections 418 and the rear trailer wheels are traveling along yellow or red lines or sections 418, this can indicate misalignment of the trailer wheels. In such embodiments, the system 400 can transmit an alert to mission control 414 to indicate a request for maintenance to correct the misalignment.

In some embodiments, the determination of axle or wheel misalignment can be performed by running the calibration procedure at least once to ensure that the sensor 406 system is properly calibrated. Once calibration is confirmed, the system 400 measures the outermost points of the front and rear wheels of the vehicle 402, as well as the trailer wheels, relative to the edges of the sections 418. Assuming the vehicle 402 is traveling on a perfectly straight section of the calibration course 416, any deviation exceeding a predetermined threshold 434 (e.g., ±10 cm, or the like) can indicate that a potential misalignment is occurring. In such cases, an alert can be transmitted to mission control 414 to request maintenance for correction of the misalignment. In some embodiments, the alignment determination can be performed at various speeds (e.g., 5 m/s, 10 m/s, 15 m/s, 20 m/s, or the like) to check for axle misalignment dynamically.

In some embodiments, calibration of the sensors 406 can be performed based on performance of the vehicle 402 during passage over or near the course features 420. As noted herein, the features 420 can include, e.g., concrete areas, paved areas, gravel areas, grass areas, loose dirt areas, wet areas, intersections, crosswalks, tunnels, bridges, traffic lights, road signs, other vehicles, combinations thereof, or the like. The sensors 406 detect one or more of the features 420 as the vehicle 402 travels along the calibration course 416. The vehicle sensor data 440 is compared to either the calibration course map 428 and/or the course characteristics 430 (e.g., known feature data for the course 416), and/or course sensor data 442 from the sensors 432.

In particular, the course sensors 432 can detect one or more of the features 420, and the system 400 compares the data to determine the accuracy value 436 for the vehicle sensor data 440. If the accuracy value 436 is within the thresholds 434 for the sensors 406, no calibration action is needed. If the accuracy value 436 is outside of the thresholds 434, the system 400 can automatically perform a calibration process for the sensors 406. After calibration, the process can be repeated to determine if the newly calibrated sensors 406 capture data 440 which is within the thresholds 434, i.e., sufficiently calibrated.

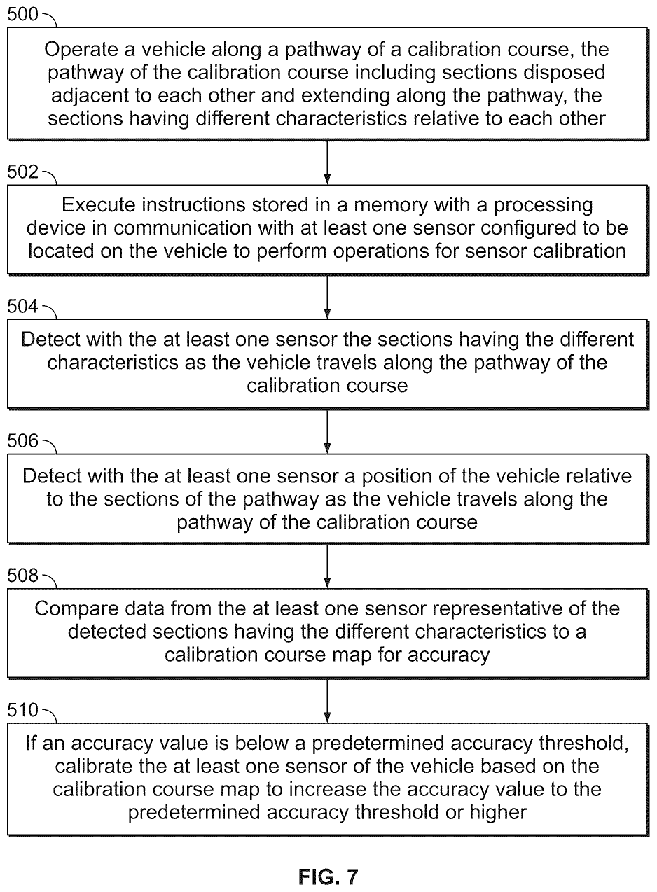

FIG. 7 is a flowchart of a method of sensor calibration by the exemplary system 400 discussed herein. At 500, a vehicle is operated along a pathway of a calibration course. The pathway of the calibration course includes sections (e.g., lines, or the like) disposed adjacent to each other and extending along the pathway. The sections have different characteristics related to each other. At 502, instructions stored in a memory are executed with a processing device in communication with at least one sensor configured to be located on the vehicle to perform operations for sensor calibration.

At 504, the sections having the different characteristics are detected with the at least one sensor as the vehicle travels along the pathway of the calibration course. At 506, a position of the vehicle relative to the sections of the pathway is detected as the vehicle travels along the pathway of the calibration course. At 508, in some embodiments, data from the at least one sensor representative of the detected sections having the different characteristics is compared to a calibration course map for accuracy. At 510, if an accuracy value is below a predetermined accuracy threshold, the at least one sensor of the vehicle is calibrated based on the calibration course map to increase the accuracy value to the predetermined accuracy threshold or higher. In some embodiments, data from the at least one sensor can be compared to data from at least one course sensor to determine if the accuracy value is below a predetermined accuracy threshold.

FIGS. 8 and 9 are diagrammatic views of a calibration course 600 for sensor calibration using the system 400. The calibration course 600 includes a roadway or pathway 602 with various lines 604, 606, 608, 610 (e.g., sections) formed or painted on the pathway 602. Although the lines 604-610 are shown immediately adjacent to each other, it should be understood that the term “adjacent” as used herein refers to near adjacent as well, e.g., laterally spaced from each other. However, the lines 604-610 follow the same curvature of the pathway 602, whether in an immediately adjacent or near adjacent configuration. In particular, the lines 604-610 generally follow the curves of the pathway 602 and define the course along which the vehicle 612 is to travel. One of the lines 604-610 can be designated as the primary line along which the vehicle 612 is configured to travel along, and the lines 604-610 can be used as reference points to determine if the vehicle 612 is operating properly, e.g., no misalignment of wheels/axles. In some embodiments, as illustrated in FIGS. 8 and 9, the lines 604-610 can include only a single line for each color.

As an example, the vehicle 612 can include a truck 614 and a trailer 616 coupled to the truck 614. In FIG. 8, the truck 614 and trailer 616 are substantially aligned, while in FIG. 9 the trailer 616 is significantly misaligned relative to the truck 614. Such misalignment can be detected by one or more sensors 618, 620, 622 disposed along the course 600. In some embodiments, only the sensors 618, 620, 622 of the course 600 can be used to determine misalignment of the wheels and/or axles of the trailer 616. In such embodiments, the sensors 618, 620, 622 can be in communication with a central processing unit 624, e.g., mission control, or the like, and detected misalignment can be transmitted to the unit 624 to request maintenance for the vehicle 612.

In some embodiments, one or more sensors of the vehicle 614 having a field-of-view 626 can be used to detect one or more features associated with the vehicle 612 (e.g., axle misalignment, or the like) and/or the course 600. Data from the vehicle 612 sensor(s) and the course sensors 618, 620, 622 can be compared to determine the accuracy (e.g., matching level) of the data, which can be used to determine if a sensor calibration should be performed for the vehicle 612 sensor(s).

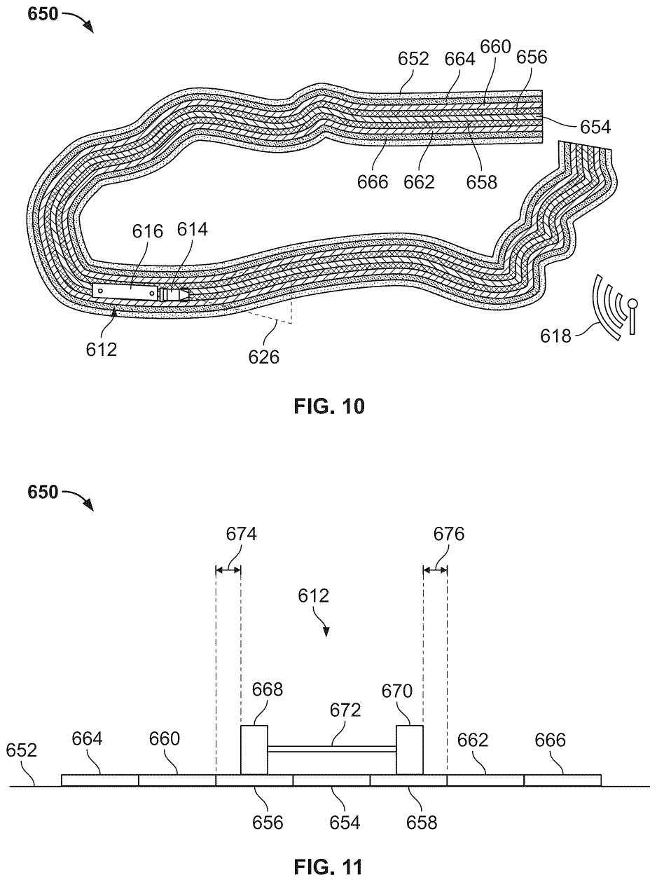

FIG. 10 is a diagrammatic view of a calibration course 650 which can be substantially similar to the calibration course 600, except that pairs of colored lines are provided. The course 650 can include a pathway 652 including a central or primary line 654 (e.g., a white line), and pairs of matching lines laterally offset on opposing sides of the primary line 654. For example, the course 650 can include a first pair of lines 656, 658 (e.g., green lines) disposed adjacent to the primary line 654, a second pair of lines 660, 662 (e.g., yellow lines) disposed adjacent to the respective lines 656, 658, and a third pair of lines 664, 666 (e.g., red lines) disposed adjacent to the respective lines 660, 662. The differently colored lines 654-555 serve as visual indicators for the sensors of the vehicle 612 and/or he course sensor 618 to detect the position of the vehicle 612 as it travels along the course 650.

FIG. 11 is a diagrammatic front view of the calibration course 650 of FIG. 10. FIG. 11 includes a partial view of the vehicle 612, e.g., the rear wheels 668, 670 and rear axle 672 of the trailer associated with the vehicle 612. As the vehicle 612 travels along the course 650, the distance 674, 676 of the respective wheels 668, 670 relative to the lines 654-666 can be determined based on the vehicle 612 sensor(s), the course sensor(s) 618, or both.

Based on the distance 674, 676, the system can determine if the axle 672 of the vehicle 612 is aligned properly or not (e.g., by comparing the distance 674, 676 to similar distances for other wheels of the vehicle 612). The distance 674, 676 can be used to determine the position of the vehicle 612 along the course 650, and this data can be compared between the vehicle 612 sensors and course sensors 618 to determine if the vehicle 612 sensors are accurately detecting the position of the vehicle 612. If a discrepancy is detected that is outside of permissible thresholds, the system can automatically calibrate the sensors of the vehicle 612 based on the course sensor 618 data.

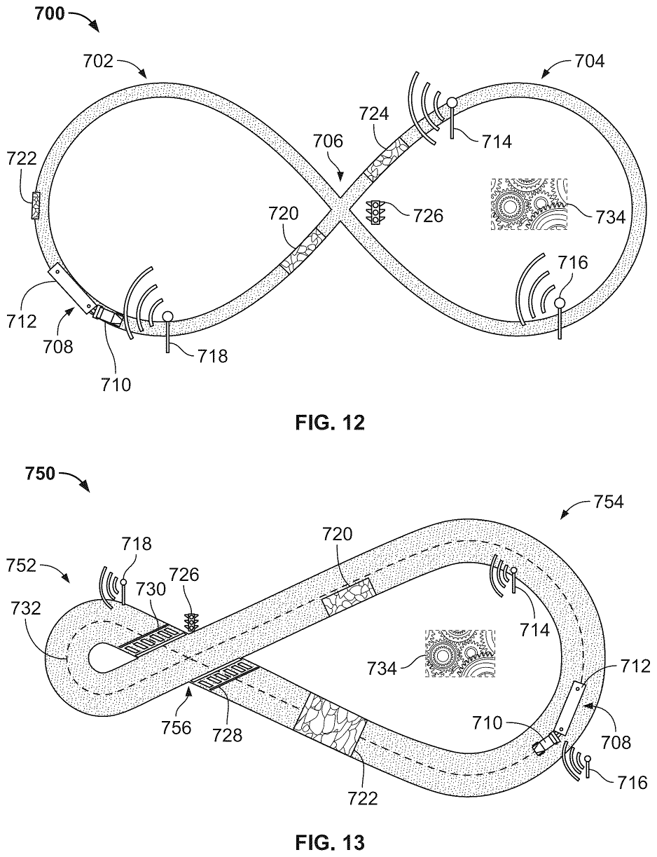

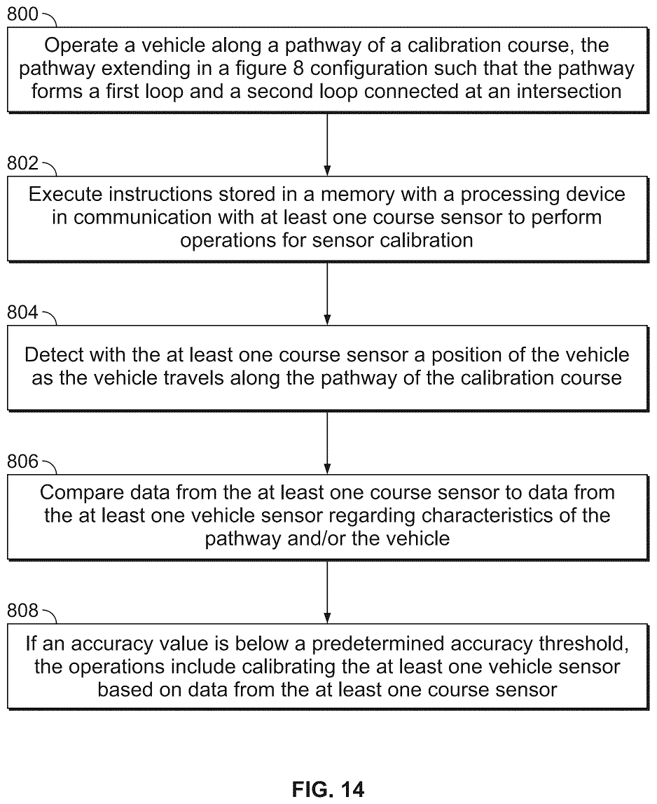

FIGS. 12 and 13 are diagrammatic top views of calibration courses 700, 750 that define a substantially figure 8 configuration, with the course 700 having a uniform configuration and the course 750 having an offset configuration. The course 700 includes a first loop 702 and a second loop 704 connected at a central intersection 706. In some embodiments, the first and second loops 702, 704 can be substantially equal in size and configuration. In some embodiments, more than two loops 702, 704 can be used. The figure 8 configuration of the course 700, 750 allows for an optimal use of geographical space, while ensuring continuity in operation of the vehicle 708 (e.g., including a truck 710 and trailer 712) during the calibration process.

The course 700, 750 can include one or more sensors 714, 716, 718 to detect characteristics associated with the vehicle 708 and/or the course 700, 750. In some embodiments, the course 700, 750 can include a generally flat terrain with minimal elevational changes. In some embodiments, the course 700, 750 can include various features intended to mimic different operational scenarios for testing of the vehicle 708. For example, the course 700, 750 can include different areas 720, 722, 724 of different terrain, e.g., concrete areas, paved areas, gravel areas, grass areas, loose dirt areas, wet areas, intersections, crosswalks, tunnels, bridges, combinations thereof, or the like. In some embodiments, the course 700, 750 can include different roadway components 726, 728, 730, 732, e.g., traffic lights, crosswalks, lane markers, combinations thereof, or the like. The course 700, 750 can therefore be operated to test the vehicle 708 in substantially real-world scenarios and conditions. As an example, the vehicle 708 can travel over gravel areas which results in dust raised into the air, and the system can determine if the vehicle 708 sensors are operating and perceiving the environment accurately through the raised dust.

The sensors 714, 716, 718 of the course 700, 750 and the sensors of the vehicle 708 can be in communication with a central processing unit 734, e.g., mission control, or the like, such that data from the sensors 714, 716, 718 can be processed to determine the accuracy of the vehicle 708 sensors. In some embodiments, the data from the vehicle 708 and/or the course sensors 714, 716, 718 can be used to determine the general operation of the vehicle 708 and if maintenance is needed. The figure 8 configuration can be of a substantially equal (e.g., mirror) dimension illustrated in FIG. 12, or can be an offset configuration illustrated in FIG. 13. For example, the course 750 of FIG. 13 can include first and second loops 752, 754 dimensioned differently and connected by an intersection 756 offset from the center of the course 750. The offset course 750 configuration can be used to, e.g., mimic sharper turns, at least two road curvatures, or the like, for the vehicle 708. The course 750 can allow for calibration of the vehicle 708 sensor system for larger hitch angles of the vehicle/trailer setup. Camera systems facing the rear of the vehicle/trailer may have a better field-of-view for larger hitch angles provided by the course 750, which increases the chance of detecting anomalies for, e.g., dog-legging trailer, axle misalignment, mechanical compliance issues, or the like) before launch of the vehicle 708.

FIG. 14 is a flowchart of a method of sensor calibration by the exemplary system 400 discussed herein, particularly with reference to the figure 8 calibration courses of FIGS. 12 and 13. At 800, a vehicle is operated along a pathway of a calibration course. The pathway extends in a figure 8 configuration such that the pathway forms a first loop and a second loop connected at an intersection. At 802, instructions stored in a memory are executed with a processing device in communication with at least one course sensor to perform operations for sensor calibration.

At 804, a position of the vehicle is detected with the at least one course sensor as the vehicle travels along the pathway of the calibration course. At 806, data from the at least one course sensor is compared to data from the at least one vehicle sensor regarding characteristics of the pathway and/or the vehicle. At 808, if an accuracy value is below a predetermined accuracy threshold for the compared data, the operations include calibrating the at least one vehicle sensor based on data from the at least one course sensor. The figure 8 course can therefore be used to calibrate sensors of the vehicle and determine the general operation of the vehicle in dynamic maneuver circumstances that mimic real-world environments.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for sensor calibration, comprising:
a calibration course including a pathway with sections disposed adjacent to each other and extending along the pathway, the sections having different characteristics relative to each other;
at least one sensor configured to be located on a vehicle; and
a processing device in communication with the at least one sensor, wherein the processing device is configured to execute instructions stored in a memory to perform operations comprising:
detecting with the at least one sensor the sections having the different characteristics as the vehicle travels along the pathway of the calibration course; and
detecting with the at least one sensor a position of the vehicle relative to the sections of the pathway as the vehicle travels along the pathway of the calibration course.

2. The system of claim 1, wherein the sections include lines and the different characteristics include different colors.

3. The system of claim 1, wherein the sections with different characteristics include a central white line, a green line laterally offset from the central white line, a yellow line laterally offset from the green line, and a red line laterally offset from the yellow line.

4. The system of claim 1, wherein the sections with different characteristics include a central white line, first and second green lines laterally offset on opposing sides of the central white line, first and second yellow lines laterally offset on opposing sides of the respective first and second green lines, and first and second red lines laterally offset on opposing sides of the respective first and second yellow lines.

5. The system of claim 1, comprising a database electronically storing a calibration course map including the pathway with the sections having the different characteristics.

6. The system of claim 5, wherein the operations comprise comparing data from the at least one sensor representative of the detected sections having the different characteristics to the calibration course map for accuracy.

7. The system of claim 6, wherein if an accuracy value is below a predetermined accuracy threshold, the operations comprise calibrating the at least one sensor of the vehicle based on the calibration course map to increase the accuracy value to the predetermined accuracy threshold or higher.

8. The system of claim 1, wherein detecting the position of the vehicle relative to the sections comprises detecting a wheel position relative to the sections of the pathway.

9. The system of claim 8, wherein the wheel position is a trailer wheel position for a trailer coupled to the vehicle.

10. The system of claim 9, wherein the operations comprise comparing the detected trailer wheel position to an expected trailer wheel position relative to the sections of the pathway based on a speed and trajectory of the vehicle.

11. The system of claim 10, wherein if the detected trailer wheel position is offset relative to the expected trailer wheel position by greater than a predetermined trailer wheel position threshold, the operations comprise identifying a trailer wheel or axle misalignment of the trailer.

12. The system of claim 1, comprising at least one course sensor disposed at or near the calibration course.

13. The system of claim 12, wherein the at least one course sensor is different from the at least one sensor of the vehicle.

14. The system of claim 12, wherein the operations comprise:
detecting with the at least one course sensor the sections having the different characteristics as the vehicle travels along the pathway of the calibration course, and comparing course sensor data with data from the at least one sensor of the vehicle for accuracy; and
if an accuracy value is below a predetermined accuracy threshold, calibrating the at least one sensor of the vehicle based on the course sensor data to increase the accuracy value to the predetermined accuracy threshold or higher.

15. The system of claim 12, wherein the operations comprise:
detecting with the at least one course sensor the position of the vehicle relative to the sections of the pathway as the vehicle travels along the pathway of the calibration course, and comparing course sensor data with data from the at least one sensor of the vehicle for accuracy; and
if an accuracy value is below a predetermined accuracy threshold, calibrating the at least one sensor of the vehicle based on the course sensor data to increase the accuracy value to the predetermined accuracy threshold or higher.

16. The system of claim 1, wherein the vehicle is an autonomous or a semi-autonomous vehicle.

17. The system of claim 1, wherein the at least one sensor is a camera, radar, and/or LiDAR.

18. A computer-implemented method for sensor calibration, comprising:
operating a vehicle along a pathway of a calibration course, the pathway of the calibration course including sections disposed adjacent to each other and extending along the pathway, the sections having different characteristics relative to each other; and
executing instructions stored in a memory with a processing device in communication with at least one sensor configured to be located on the vehicle to perform operations comprising:
detecting with the at least one sensor the sections having the different characteristics as the vehicle travels along the pathway of the calibration course; and
detecting with the at least one sensor a position of the vehicle relative to the sections of the pathway as the vehicle travels along the pathway of the calibration course.

19. The method of claim 18, wherein the operations comprise:
comparing data from the at least one sensor representative of the detected sections having the different characteristics to a calibration course map for accuracy; and
if an accuracy value is below a predetermined accuracy threshold, calibrating the at least one sensor of the vehicle based on the calibration course map to increase the accuracy value to the predetermined accuracy threshold or higher.

20. The method of claim 18, wherein the operations comprise:
detecting the position of the vehicle relative to the sections by detecting a wheel position relative to the sections of the pathway;
comparing the detected wheel position to an expected wheel position relative to the sections of the pathway; and
if the detected wheel position is offset relative to the expected wheel position by greater than a predetermined wheel position threshold, the identifying a wheel or axle misalignment of the vehicle.
